(19) United States
(12) Patent Application Publication
(10) Pub. No.: US 2005/0235785 A1
(43) Pub. Date: Oct. 27, 2005

(54) Multi-angle adjusting socket body and improved structure of its tools

(76) Inventor: Sheng - Ming Chang, Daya Township (TW)

Correspondence Address: CHARLES E. BAXLEY, ESQ., 90 JOHN STREET, THIRD FLOOR, NEW YORK, NY, 10038, US

(21) Appl. No.: 10/830,276

(22) Filed: Apr. 21, 2004

(51) Int. Cl. B25B 23/00

(52) U.S. Cl. 81/177.75

(57) ABSTRACT

A multi-angle adjusting socket body and improved structure of its tools mainly comprises a connecting shaft with one end formed as a multi-angular socket for inserting a tool, a locking sleeve with elasticity and pressing forces for positioning the tool, the tool having one end formed as a sleeving section in ball shape, another end formed as a driving part, a turning concave part and a plurality of indentations are disposed on the circumference of the tool between the sleeving section and the driving part, accordingly, when the sleeving section of the tool is inserted into the multi-angular socket and is used in straight manner, the positioning piece of the locking sleeve presses against on the positioning indentation, so that the operation is performed more stably and firmly, when the tool is used in angular manner, the positioning piece presses against on the turning concave part, thus the tool can be adjusted in different angles.

### BACKGROUND OF THE INVENTION

Referring to FIGS. 1 and 2, a “driven tool” such as a ratchet wrench or an electrical tool having a conventional direction—turning connecting shaft (91), its one end having a driven head (92), a concave part (93) is disposed between the connecting shaft (91) and the driven head (92), so that the connecting shaft (91) can turn in a angle. A shoulder (94) is disposed between the concave part (93) and the connecting shaft (91), so that the shoulder (94) can contact the inner surface of a socket (95) to enhance the connection of the socket (95) and the connecting shaft (91) when the driven head (92) is being sleeved with socket (95).

The disadvantages of the conventional are as follows. The connecting method between the connecting shaft and the socket is simply a sleeving method, they are easily to fall apart during usage. Regardless of the usage of the socket and the connecting shaft is in a straight line or in an angle, or during the procedure when the socket is driven by the wrench, the force is improperly applied on the driven head of the connecting shaft, or the holding angle of the wrench is not properly adjusted, detachment will occur. The output power is fairly large for electrical or pneumatic tools, if the connecting shaft and the socket fall apart during applying torque, safety will be affected.

Another prior art as shown in FIGS. 3 and 4, with a Publication number of 506313, a Multi-Purpose Connecting Shaft”, it comprises a connecting shaft 81, with its one end having a ball shaped sleeving part 82, a concave part is formed between the sleeving part 82 and the connecting shaft 81. The side of the concave part which connecting to the connecting shaft 81 is formed as a locking part. The sleeving part 82 having a placing space 83 disposed axially. On the circumference of the connecting shaft 81 having a ball hole disposed horizontally for placing a steel ball 84, the ball hole is also connected to the placing space 83. A locking hole is also disposed on the circumference of the connecting shaft 81, the locking hole is connected to the enclosed end of the placing space 83. A locking piece 85 is disposed inside the placing space 83 and can be displaced in correspond to the placing space 83. The locking piece 85 having a first end and a second end. At least one sliding surface and a pressing surface are disposed at the first end. The second end having a concave part, one end inside the concave part having an adjusting surface. A control piece 86 is placed inside the locking hole, and an elastic body 87 is disposed between the control piece 86 and the connecting shaft 81, so that the control piece 86 can be displaced in correspond to the locking hole.

Even though the connecting shaft and the socket are more firmly connected by the mechanism of the locking piece, the control piece and the elastic body, and the also makes it easier for changing tools, but it has the follow disadvantages. Referring to FIG. 3, when using in a straight line, the steel ball is not in fixed position which means the socket will easily detach from the connecting shaft. Referring to FIG. 4, when using in an angle, even though the steel ball will be fixed on the concave hole of the socket, so that the connection between the connecting shaft and the socket is firmly fixed, nevertheless, the connection is simply in fixed along the circumference, therefore when the socket angle is being adjusted, it will easily shake to make it inconvenient for the user to operate.

Furthermore, the above mentioned connecting shaft having turning function is usually used in socket, and is not suitable for hand tools such as hexagonal screw head. The present invention has the primary purpose of improving the practicality of the connecting shaft with angle turning function, and a second purpose of enhancing its applicability

### SUMMARY OF THE INVENTION

The present invention comprises a connecting shaft, a locking sleeve for connecting to one end of the connecting shaft, and a tool for connecting to another end of the connecting shaft. The connecting shaft having one end formed as a multi-angular socket for inserting the tool, the inner surface of the multi-angular socket a groove for connecting to the outside, the locking sleeve is sleeved on the multi-angular socket, it comprises an inner bushing, a sliding piece, an elastic piece and a positioning piece. The inner bushing is sleeved on the groove of the connecting shaft, a ball hole is disposed on the inner bushing in corresponding to the groove for placing the positioning piece. The sliding piece is sleeved on the outer end of the connecting shaft, it comprises an outer sleeve and a positioning buckle. The outer sleeve having a stopping part protruded from the inner surface of the outer end, the positioning buckle is buckled on the connecting shaft in corresponding to the stopping part for pressing against the stopping part. When the outer sleeve is connected with the connecting shaft, the elastic piece is disposed between the inner bushing and the stopping part, a stopping edge and a receiving edge of sectional structure are disposed on the inner surface of the elastic piece in neighboring to each other. Another elastic piece is disposed between the other end of the sliding piece and the inner bushing, so that one end of the positioning piece is pressed against by the stopping edge of the sliding piece, and another end is slightly protruded from the groove, so the it is in the way blocking the screw driver inserting path. One end of the tool is connected to a sleeving section of the connecting shaft, another end is formed as a driving part for driving a screw, a turning receiving edge and a plurality of positioning indentations are disposed on the circumference between the sleeving section and the driving part. Accordingly, when the sleeving section of the tool is sleeved inside the multi-angular socket and used in a straight manner, the positioning piece of the locking sleeve is pressed against the positioning indentation to make the operation more stable and firm. When the tool is used in an angular manner, the positioning piece is pressed against the turning receiving edge to make the tool to be able to turn freely.

The present invention will become more fully understood by reference to the following detailed description thereof when read in conjunction with the attached drawings.

### BRIEF DESCRIPTION OF THE DRAWINGS

FIG. 1 is a sectional view of a first conventional invention;

FIG. 2 is another sectional view of a first conventional invention;

FIG. 3 is a sectional view of a second conventional invention;

FIG. 4 is another sectional view of a second conventional invention;

FIG. 5 is a perspective view of the present invention;

FIG. 6 is a perspective exploded view of the present invention;

FIG. 7 is a sectional assembly view of the present invention;

FIG. 8 is a sectional assembly view of the present invention when used in a straight manner;

FIG. 9 is a sectional assembly view of the present invention when used in an angular manner;

FIG. 10 is an assembly view of a second embodiment of a tool of the present invention;

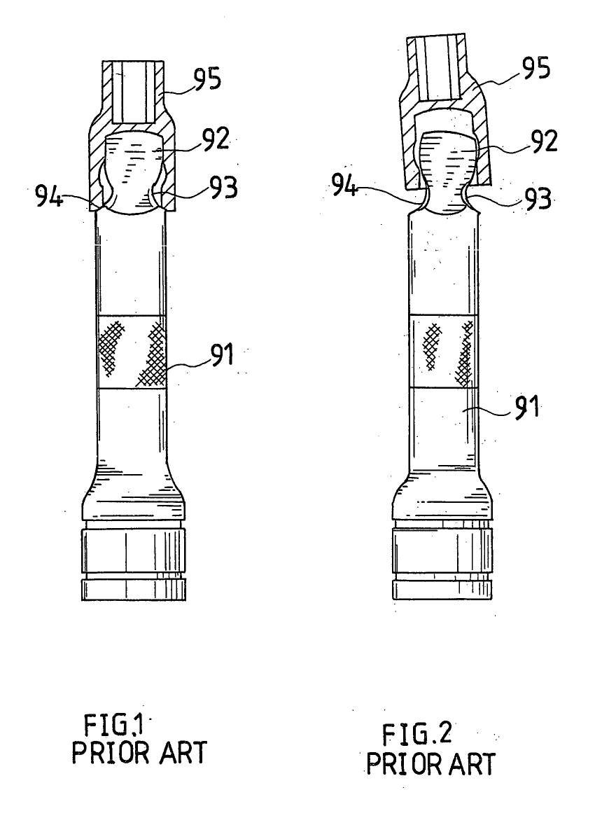

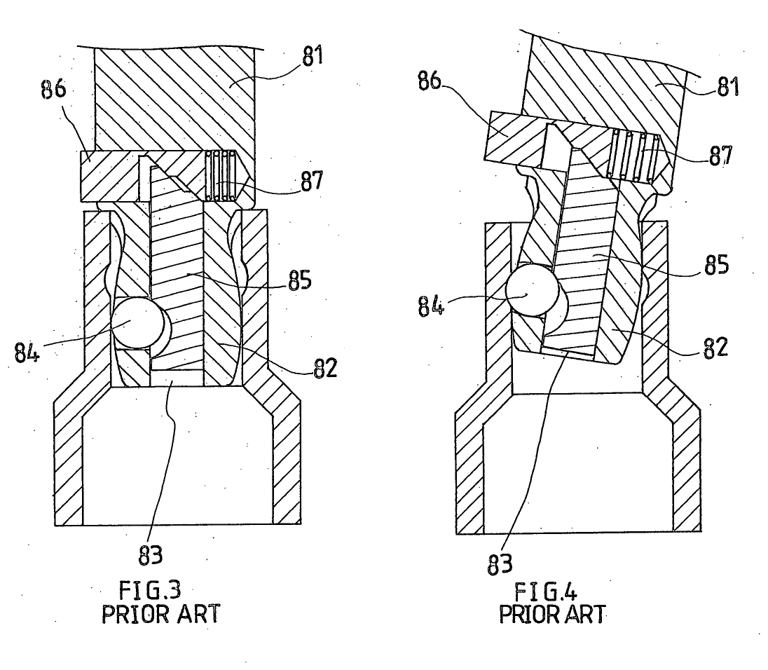

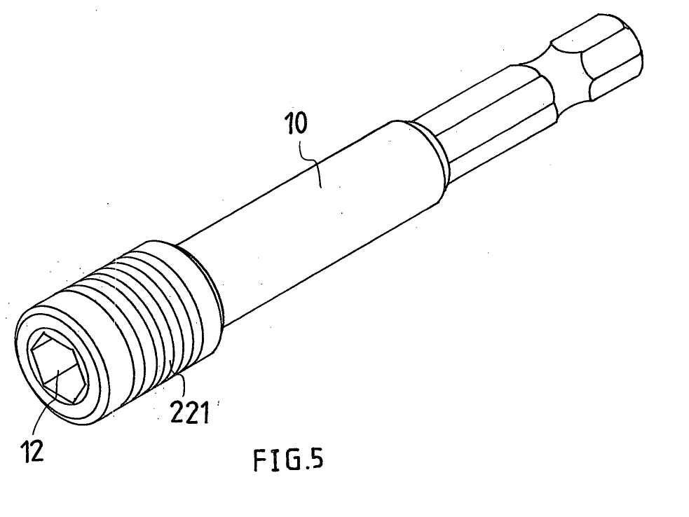

### DETAILED DESCRIPTION OF THE PREFERRED EMBODIMENT

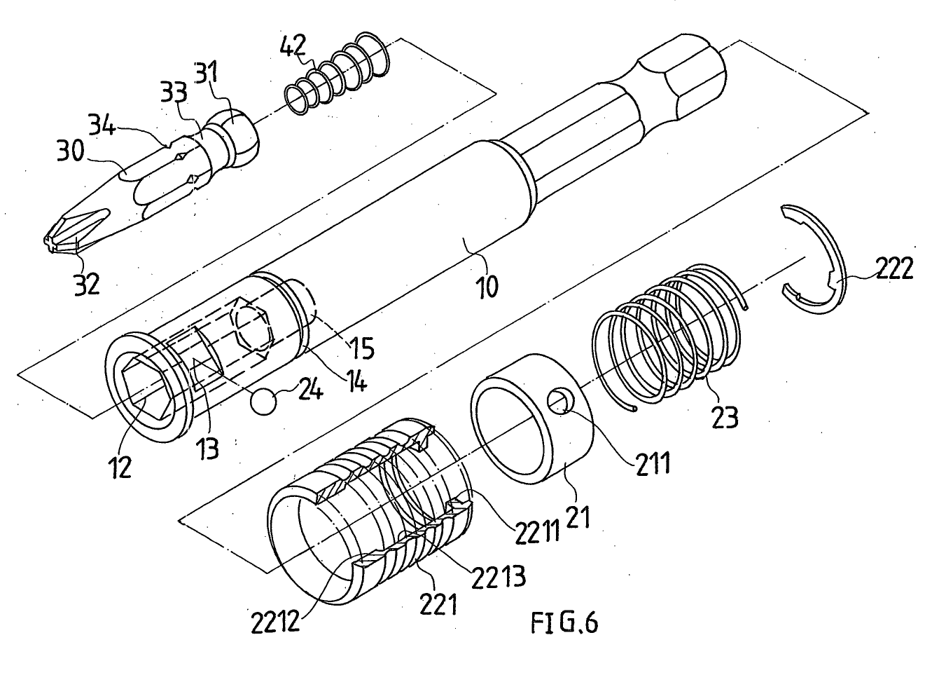

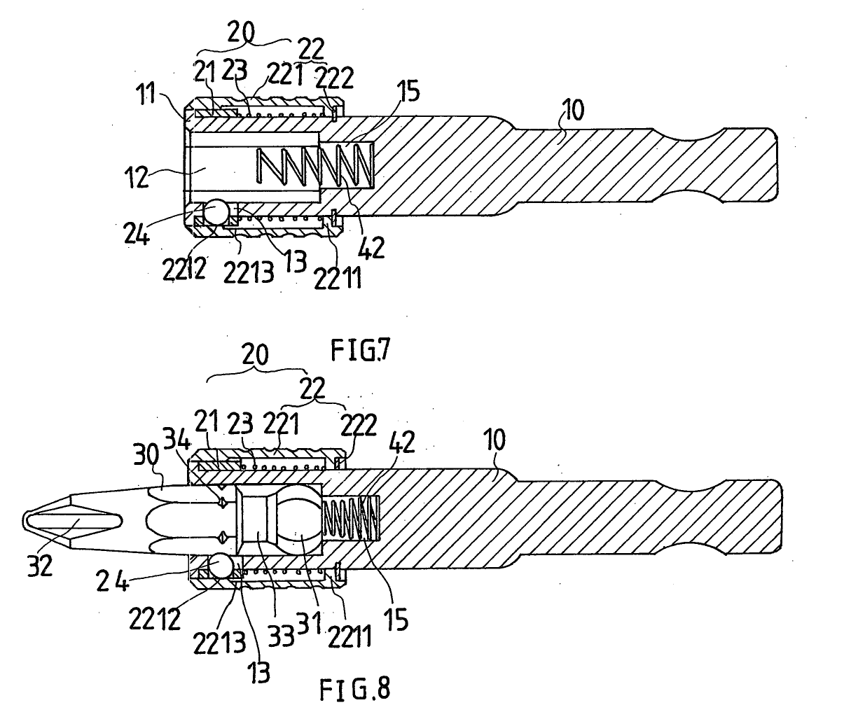

Referring to FIGS. 5 to 8, the present invention comprises a connecting shaft 10, a locking sleeve 20 for sleeving on one end of the connecting shaft 10, and a tool 30 for connecting to one end of the connecting shaft 10.

The connecting shaft 10 having a limiting part 11 protruded from one end, and a multi-angular socket 12 for inserting the tool 30. The other end having a connecting section 15 for connecting to power tool such as a wrench or an electrical screwdriver. The multi-angular socket 12 having a groove 13 disposed on the inner surface in corresponding to the tool 30 of multi-angular structure, the locking sleeve 20 is sleeved on it. A ring groove 14 is disposed around the multi-angular socket 12 in corresponding to the locking sleeve 20. The multi-angular socket 12 having a groove hole 15 extended from it and connecting to each other, the groove hole 15 having an elastic spring 42.

The locking sleeve 20 comprises an inner bushing 21, a sliding piece 22, an elastic piece 23 and a positioning piece 24. The inner bushing 21 is sleeved on the connecting shaft 10 where the groove 13 is disposed, a ball hole 211 is disposed on the inner bushing 21 in corresponding to the groove 13 for placing the positioning piece 24.

The sliding piece 22 comprises an outer sleeve 221 and a positioning buckle ring 222, a stopping part 2211 is disposed on the inner surface of the rear end of the outer sleeve 221, a stopping edge 2212 and a receiving edge 2213 of sectional structure are disposed in neighboring to each other on the inner surface of its front end, in corresponding to the positioning piece 24.

The elastic piece 23 is sleeved on the connecting shaft 10, and is disposed between the inner bushing 21 and the stopping part 2211 of the outer sleeve 221. The positioning piece 24 is a steel ball and can be placed inside the ball hole 211 of the inner bushing 21 and the groove 13 of the connecting shaft 10 at the same time. Its one end is pressed against by the stopping edge 2212 so that the other end is slightly protruded from the groove 13, on the path which the tool 30 inserting into the multi-angular socket 12.

The tool 30 is a tool for driving a hexagonal working piece, its one end is formed as a ball shape, which is a sleeving section 31 for connecting to the multi-angular socket 12, the other end is a driving part 32 for driving a hexagonal working piece, a turning concave part 33 and a plurality of positioning indentations 34 are disposed on the circumference between the sleeving section 31 and the driving part 32. Either the turning concave part 33 or the positioning indentations 34 is pressing against and positioned by the positioning piece 24 of the locking sleeve 20 depend on the usage of the tool 30.

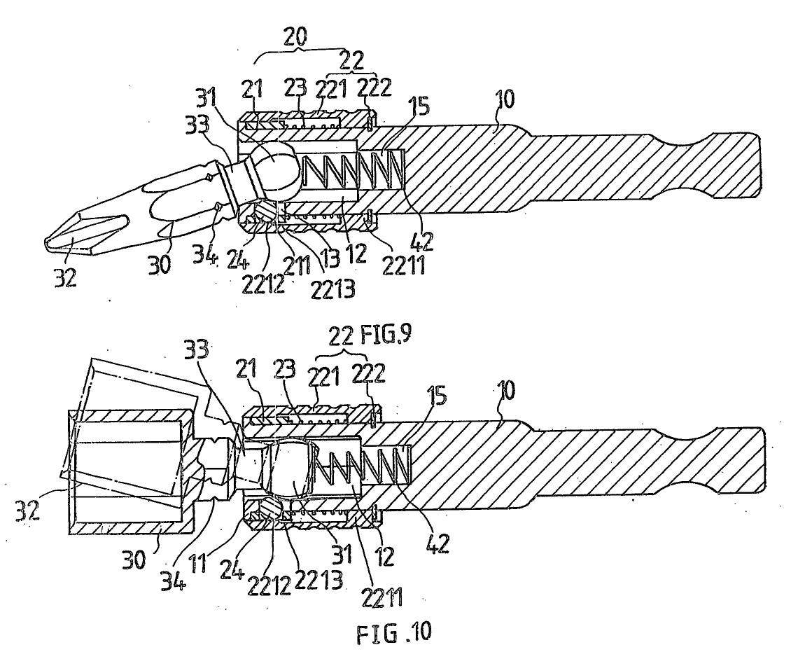

Referring to FIGS. 8 and 10, the driving part 32 of the tool 30 can be formed as a screwdriver structure, or a socket structure. If it is a screwdriver structure, the sleeving section 31 and the multi-angular socket 12 will have a hexagonal structure, when the driving part 32 is formed as a socket structure, the sleeving section 31 and the multi-angular socket 12 will have a socket structure.

Accordingly, insert the sleeving section 31 of the tool 30 into the multi-angular socket 12, it will work in either straight or angular manner stably and firmly. Users can control the sleeving section 31 to insert into or detach from the multi-angular socket 12 by one hand.

Referring to FIG. 8, when the tool 30 is used in straight manner, the sleeving section 31 is sleeved inside the multi-angular socket 12, so that one end of the positioning piece 24 presses against the positioning indentation 34. During the stage when one end of the tool 30 is inserted into the multi-angular socket 12, its end will press against on the positioning piece 24 first, then the inner bushing 21 displaces and presses against on the elastic piece 23, when the positioning piece 24 fall into the stopping edge 2212 of the outer sleeve 221, the tool 30 is then positioned. The positioning piece 24 will returns back to its original position after the absence of the pressing force and the elasticity of the elastic piece 23, and it is then locked on the positioned indentation 34 of the tool 30. Thus, users can sleeve the tool 30 in the multi-angular socket 12 by only using one hand.

Referring to FIG. 9, when the tool 30 is used in an angular manner, the sleeving section 31 is disposed near the outer end of the multi-angular socket 12, so that the positioning piece 24 presses against on the turning concave part 33, and the tool 30 can be adjusted in different angles freely. In order to end the tool 30 from the straight usage manner, simply push the outer sleeve 221 towards the multi-angular socket 12 to make the positioning piece 24 to fall into the stopping edge 2212, thus the detach the positioning piece 24 from the tool 30. In the meantime, the spring 42 will presses against on the tool 30 to displace, to make the turning concave part 33 presses against on the positioning piece 24. Because the spring 42 is continuously pressing against on the tool 30, so the adjusting and turning of angles will be more stably and firmly.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

1. A multi-angle adjusting socket body and improved structure of its tools mainly comprises a connecting shaft, its one end is a multi-angular socket for inserting a tool, a groove is disposed on the inner surface of said multi-angular socket and is connected to the outside, a locking sleeve is sleeved on said connecting shaft;
a locking socket which is an element to position said tool by elasticity;
said tool having a sleeving section in ball shape disposed at its one end, another end is a driving part, a turning concave part and a plurality of positioning indentations are disposed around the circumference between said sleeving section and driving part;
accordingly, said sleeving section of said tool is inserted into said multi-angular socket, it works stably and firmly both in straight and angle turning manner, users can also control said sleeving section to insert into or detach from said multi-angular socket by using one hand.

2. A multi-angle adjusting socket body and improved structure of its tools as claimed in claim 1, said groove can be in longitudinal or round shape.

3. A multi-angle adjusting socket body and improved structure of its tools as claimed in claim 1, said inner bushing is sleeved on said connecting shaft where said groove is disposed, a ball hole is disposed on said inner bushing in corresponding to said groove for placing said positioning piece, said sliding piece is sleeved on the front end of said connecting shaft, a stopping edge and a receiving edge of sectional structure are disposed in neighboring to each other on the inner surface of its front end, in corresponding to said positioning piece, said elastic piece is disposed between the other end of said sliding piece and said inner bushing, so that one end of said positioning piece is pressed against by said stopping edge of said sliding piece, thus the other end is slightly protruded from said groove lying on the path where a screwdriver is inserted.

4. A multi-angle adjusting socket body and improved structure of its tools as claimed in claim 1 or claim 3, said sliding piece comprises an outer sleeve and a positioning buckle ring, a stopping part is protruded from the inner surface of the rear end of said outer sleeve, said positioning buckle ring is disposed on said connecting shaft in corresponding to said stopping part for pressing against said stopping part, when said outer sleeve is connected with said connecting shaft, said elastic piece is disposed between said inner bushing and said stopping part, and said stopping edge and said receiving edge are disposed on the inner surface of said outer sleeve.

5. A multi-angle adjusting socket body and improved structure of its tools as claimed in claim 1, when said tool is used in straight manner, said sleeving section is sleeved inside said multi-angular socket, so that on end of said positioning piece presses against said positioning indentation.

6. A multi-angle adjusting socket body and improved structure of its tools as claimed in claim 1, when said tool is used in angular manner, said sleeving section is sleeved on said multi-angular socket, so that said positioning piece presses against said turning concave part, thus said tool can be adjusted to turn in different angle.

7. A multi-angle adjusting socket body and improved structure of its tools as claimed in claims 1 and 6, said multi-angular socket having a groove as an extension and are connected to each other, a spring is disposed inside said groove, when said tool is used in straight manner, said spring is being pressed, on the contrary, when the straight usage manner stops for said tool, said spring pushes said positioning indentation to detach from said positioning piece, when users continue to adjust the turning angle, said spring presses against said tool so that the operation is more stably and firmly.

8. A multi-angle adjusting socket body and improved structure of its tools as claimed in claims 1, said driving part of said tool can be in screwdriver structure or socket structure, if in screwdriver structure, said sleeving section and said multi-angular socket are in hexagonal shape, if in socket structure, said sleeving section and multi-angular socket are in socket structure.

9. A multi-angle adjusting socket body and improved structure of its tools having a connecting shaft with one end formed as a multi-angular socket for inserting a tool, a locking sleeve with elasticity and pressing forces is sleeved on said multi-angular socket for positioning said tool, one end of said tool having is a sleeving section in ball shape, another end is a driving part, a turning concave part and at least one indentation are disposed on the circumference between said sleeving section and said driving part, accordingly, when said sleeving section of said tool is sleeved inside said multi-angular socket and is used in straight manner, said positioning piece of said locking sleeve presses against said positioning indentation to make the operation more stably and firmly, when said tool is used in angular manner, said positioning piece presses against on said turning concave part, so that said tool can be adjusted in different angles.

10. A multi-angle adjusting socket body and improved structure of its tools as claimed in claim 9, said locking sleeve comprises an inner bushing, a sliding piece, an elastic piece and a positioning piece, said inner bushing is sleeved on said connecting shaft where said groove is disposed, a ball hole is disposed on said inner bushing in corresponding to said groove for placing said positioning piece, said sliding piece is sleeved on the front end of said connecting shaft, a stopping edge and a receiving edge of sectional structure are disposed in neighboring to each other on the inner surface of its front end, in corresponding to said positioning piece, said elastic piece is disposed between the other end of said sliding piece and said inner bushing, so that one end of said positioning piece is pressed against by said stopping edge of said sliding piece, thus the other end is slightly protruded from said groove lying on the path where a screwdriver is inserted.

11. A multi-angle adjusting socket body and improved structure of its tools as claimed in claim 9, said multi-angular socket having a groove as an extension and are connected to each other, a spring is disposed inside said groove, when said tool is used in straight manner, said spring is being pressed, on the contrary, when the straight usage manner stops for said tool, said spring pushes said positioning indentation to detach from said positioning piece, when users continue to adjust the turning angle, said spring presses against said tool so that the operation is more stably and firmly.

12. A multi-angle adjusting socket body and improved structure of its tools as claimed in claims 9, said driving part of said tool can be in screwdriver structure or socket structure, if in screwdriver structure, said sleeving section and said multi-angular socket are in hexagonal shape, if in socket structure, said sleeving section and multi-angular socket are in socket structure.
